(19) United States
(12) Patent Application Publication
(10) Pub. No.: US 2023/0129342 A1
(43) Pub. Date: Apr. 27, 2023

(54) COMMUNICATION SYSTEM

(71) Applicants: KABUSHIKI KAISHA TOSHIBA, Minato-ku, Tokyo (JP); TOSHIBA DIGITAL SOLUTIONS CORPORATION, Kawasaki-shi, Kanagawa (JP)

(72) Inventor: Atsushi KAKEMURA, Kokubunji Tokyo (JP)

(73) Assignees: KABUSHIKI KAISHA TOSHIBA, Minato-ku, Tokyo (JP); TOSHIBA DIGITAL SOLUTIONS CORPORATION, Kawasaki-shi, Kanagawa (JP)

(21) Appl. No.: 17/800,434

(22) PCT Filed: Feb. 17, 2021
(86) PCT No.: PCT/JP2021/005840

§ 371 Date: Aug. 17, 2022

(30) Foreign Application Priority Data
Feb. 28, 2020 (JP) 2020-033834

(51) Int. Cl. H04W 4/06; G10L 15/08; G10L 15/22; G10L 15/30; H04W 4/12

(52) U.S. Cl. CPC H04W 4/06; G10L 15/08; G10L 15/22; G10L 15/30; H04W 4/12; G10L 2015/088; G10L 2015/223

(57) ABSTRACT

A communication system includes a management system connected to plural mobile communication terminals through wireless communication and configured to broadcast utterance voice data received from one of the mobile communication terminals to the other mobile communication terminals, to chronologically accumulate the result of utterance voice recognition from voice recognition processing on the received utterance voice data as a user-to-user communication history, and to control text delivery such that the communication history is displayed on the mobile communication terminals in synchronization. Each mobile communication terminal is configured to store notification setting information including a keyword and a predetermined notification function associated with the keyword and provided for the mobile communication terminal, to reproduce the received utterance voice data, display the result of utterance voice recognition, and perform operation control for the notification function associated with the keyword included in the result of utterance voice recognition.

### TECHNICAL FIELD

Embodiments of the present invention relate to a technique for assisting in communication using voice and text (for sharing of recognition, conveyance of intention and other purposes).

### BACKGROUND ART

Communication by voice is performed, for example, with transceivers. A transceiver is a wireless device having both a transmission function and a reception function for radio waves and allowing a user to talk with a plurality of users (to perform unidirectional or bidirectional information transmission). The transceivers can find applications, for example, in construction sites, event venues, and facilities such as hotels and inns. The transceiver can also be used in radio-dispatched taxis, as another example.

### Prior Art Documents

### Patent Documents

[Patent Document 1] International Publication WO 2005-055089
[Patent Document 2] International Publication WO 2019-031007

### DISCLOSURE OF THE INVENTION

### Problems to Be Solved by the Invention

It is an object of the present invention to provide a function of allowing a called user to notice a calling from another user when the called user fails to hear the utterance voice of the other user, thereby improving quality of information transmission among a plurality of users.

### Means for Solving the Problems

According to an embodiment, in a communication system, a plurality of users carry their respective mobile communication terminals, and the voice of utterance of one of the users input to his mobile communication terminal is broadcast to the mobile communication terminals of the other users. The communication system includes a communication management apparatus connected to each of the mobile communication terminals through wireless communication. The communication management apparatus includes a communication control section having a first control section configured to broadcast utterance voice data received from one of the mobile communication terminals to the other mobile communication terminals and a second control section configured to chronologically accumulate the result of utterance voice recognition from voice recognition processing on the received utterance voice data as a user-to-user communication history and to control text delivery such that the communication history is displayed on the mobile communication terminals in synchronization. Each of the mobile communication terminals includes a notification setting section configured to control registration of notification setting information including a keyword and a predetermined notification function associated with the keyword, the predetermined notification function being provided for the mobile communication terminal, and a user application control section configured to perform processing of reproducing the utterance voice data received from the communication management apparatus, processing of displaying the result of utterance voice recognition, local check processing of matching the result of utterance voice recognition with the keyword included in the notification setting information, and operation control for the notification function associated with keyword included in the result of utterance voice recognition.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 A diagram showing the configuration of a network of a communication system according to Embodiment 1.

FIG. 2 A block diagram showing the configurations of a communication management apparatus and a user terminal according to Embodiment 1.

FIG. 3 A diagram showing exemplary user information and exemplary group information according to Embodiment 1.

FIG. 4 A diagram showing exemplary screens displayed on user terminals according to Embodiment 1.

FIG. 5 A diagram showing an exemplary notification setting screen on a user terminal and exemplary notification setting information according to Embodiment 1.

FIG. 6 A diagram showing a flow of processing performed in the communication system according to Embodiment 1.

FIG. 7 A block diagram showing the configurations of a communication management apparatus and a user terminal according to Embodiment 2.

FIG. 8 A diagram showing exemplary user notification setting information according to Embodiment 2.

FIG. 9 A diagram showing a flow of processing performed in a communication system according to Embodiment 2.

FIG. 10 A block diagram showing the configurations of a communication management apparatus and a user terminal according to Embodiment 3.

FIG. 11 A diagram showing exemplary user notification setting information according to Embodiment 3.

FIG. 12 A diagram showing a flow of processing performed in a communication system according to Embodiment 3.

### MODE FOR CARRYING OUT THE INVENTION

### Embodiment 1

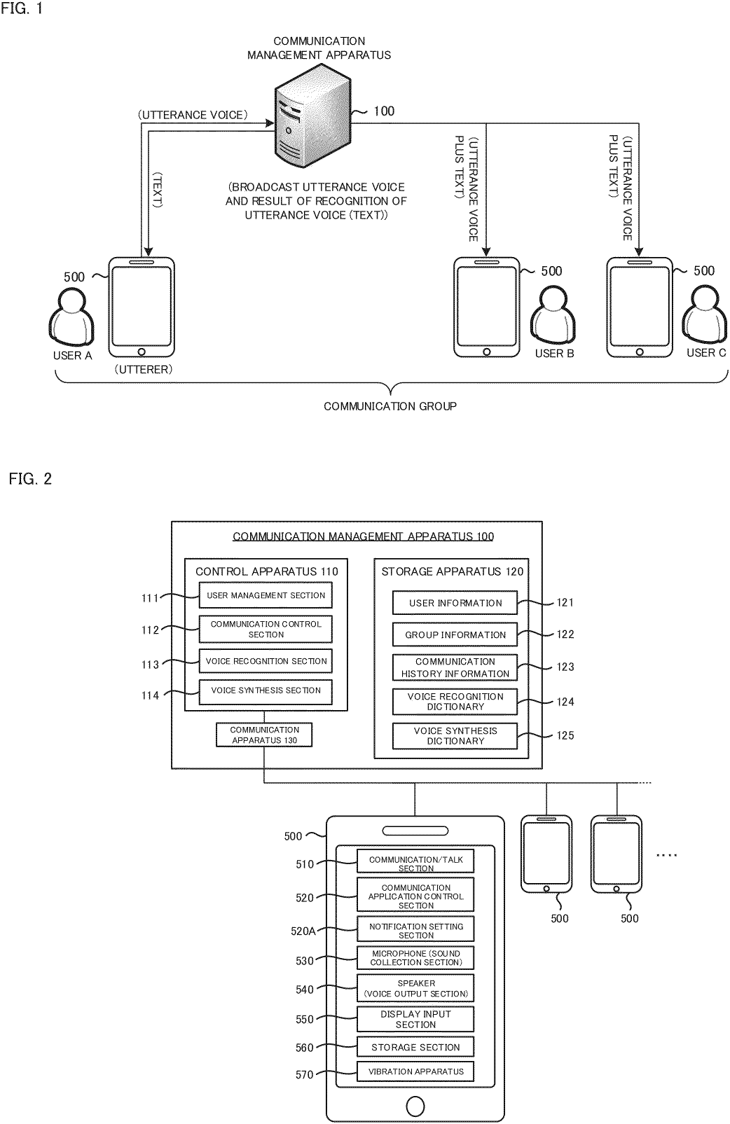

FIGS. 1 to 6 are diagrams showing the configuration of a network of a communication system according to Embodiment 1. The communication system provides an information transmission assistance function with the use of voice and text such that a communication management apparatus (hereinafter referred to as a management apparatus) 100 plays a central role. An aspect of using the communication system for operation and management of facilities such as accommodation facilities is described below, by way of example.

The management apparatus 100 is connected to user terminals (mobile communication terminals) 500 carried by users through wireless communication and broadcasts utterance voice (speech voice) data received from one of the user terminals 500 to the user terminals 500.

The user terminal 500 may be a multi-functional cellular phone such as a smartphone, or a portable terminal (mobile terminal) such as a Personal Digital Assistant (PDA) or a tablet terminal. The user terminal 500 has a communication function, a computing function, and an input function, and connects to the management apparatus 100 through wireless communication over the Internet Protocol (IP) network or Mobile Communication Network to perform data communication.

A communication group is set to define the range in which the utterance voice of one of the users can be broadcast to the user terminals 500 of the other users (or the range in which a communication history, later described, can be displayed in synchronization). Each of the user terminals 500 of the relevant users (field users) is registered in the communication group.

The communication system according to Embodiment 1 assists in information transmission for sharing of recognition, conveyance of intention and other purposes based on the premise that the plurality of users can perform hands-free interaction with each other. Specifically, the communication system has a function of notifying a called user of a calling by controlling each user terminal 500 to perform a predetermined notification operation when an utterance voice includes a specified keyword, in addition to functions of reproduction of utterance voice data and display of text.

For example, to hear the utterance voice of any user, a user can connect an earphone to his user terminal 500 and hear the utterance voice received from the management apparatus 100 through the earphone. When he removes the earphone for customer serving or other reasons, he cannot hear the utterance voice of the calling user. Since the calling side receives no reaction from the called side, the calling side may make an additional call to make sure that they are in communication with each other, which means an extra communication. The called side needs to operate his user terminal 500 to see the received result of voice recognition (in text form) corresponding to the utterance voice data. This “failure to hear the voice” may disturb smooth communication to discourage the user’s motivation to communicate, thereby often leading to inefficient communication.

To address this, in Embodiment 1, each user can register a predetermined keyword, and when the registered keyword is present in the result of voice recognition corresponding to utterance voice data received on a user terminal 500, the user terminal 500 can provide the function of performing the predetermined notification operation to allow the called side to know the calling even when the “failure to hear the voice” of the utterance occurs. This configuration achieves improvement of the communication environment.

FIG. 2 is a block diagram showing the configurations of the management apparatus 100 and the user terminal 500.

The management apparatus 100 includes a control apparatus 110, a storage apparatus 120, and a communication apparatus 130. The communication apparatus 130 manages communication connection and controls data communication with the user terminals 500. The communication apparatus 130 controls broadcast to distribute the utterance voice data from one of the users and text information representing the content of the utterance (text information provided through voice recognition processing on the utterance voice data) to the user terminals 500 at the same time.

The control apparatus 110 includes a user management section 111, a communication control section 112, a voice recognition section 113, and a voice synthesis section 114. The storage apparatus 120 includes user information 121, group information 122, communication history (communication log) information 123, a voice recognition dictionary 124, and a voice synthesis dictionary 125.

The voice synthesis section 114 and the voice synthesis dictionary 125 provides a voice synthesis function of receiving a character information input of text form on the user terminal 500 or a character information input of text form on an information input apparatus other than the user terminal 500 (for example, a mobile terminal or a desktop PC operated by a manager, an operator, or a supervisor), and converting the character information into voice data. However, the voice synthesis function in the communication system according to Embodiment 1 is an optional function.

In other words, the communication system according to Embodiment 1 may not have the voice synthesis function. When the voice synthesis function is included, the communication control section 112 of the management apparatus 100 receives text information input on the user terminal 500, and the voice synthesis section 114 synthesizes voice data corresponding to the received text characters with the voice synthesis dictionary 125 to produce synthesized voice data. The synthesized voice data can be produced from any appropriate materials of voice data. The synthesized voice data and the received text information are broadcast to the other user terminals 500.

The user terminal 500 includes a communication/talk section 510, a communication application control section (user application control section) 520, a notification setting section 520A, a microphone 530, a speaker 540, a display input section 550 such as a touch panel, a storage section 560, and a vibration apparatus 570. The speaker 540 is actually formed of earphones or headphones (wired or wireless). The vibration apparatus 570 is an apparatus for vibrating the user terminal 500.

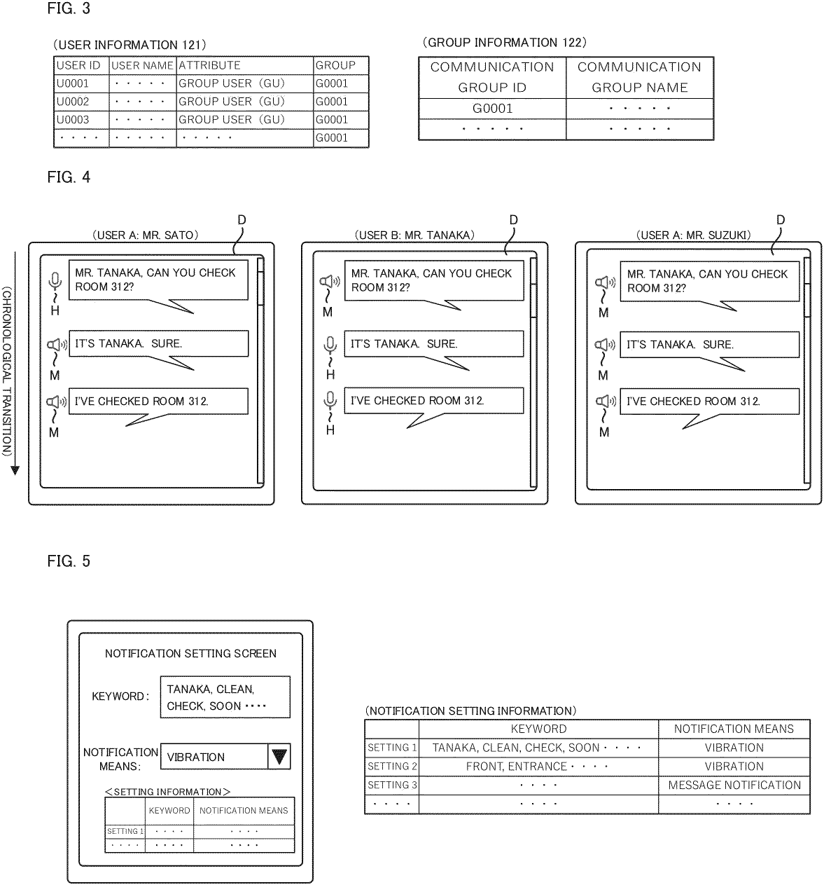

FIG. 3 is a diagram showing examples of various types of information. User information 121 is registered information about users of the communication system. The user management section 111 controls a predetermined management screen to allow setting of a user ID, user name, attribute, and group on that screen. The user management section 111 manages a list of correspondences between a history of log-ins to the communication system on user terminals 500, the IDs of the users who logged in, and identification information of the user terminals 500 of those users (such as MAC address or individual identification information specific to each user terminal 500).

Group information 122 is group identification information representing separated communication groups. The communication management apparatus 100 controls transmission/reception and broadcast of information for each of the communication groups having respective communication group IDs to prevent mixed information across different communication groups. Each of the users in the user information 121 can be associated with the communication group registered in the group information 122.

The user management section 111 according to Embodiment 1 controls registration of each of the users and provides a function of setting a communication group to perform first control (broadcast of utterance voice data) and second control (broadcast of an agent utterance text and/or a text representing the result of recognition of a user’s utterance voice), as later described.

Depending on the specific facility in which the communication system according to Embodiment 1 is introduced, grouping can be used to perform facility management by classifying the facility into a plurality of divisions. In an example of an accommodation facility, bellpersons (porters), concierges, and housekeepers (cleaners) can be classified into different groups, and the communication environment can be established such that hotel room management is performed within each of those groups. In another viewpoint, communications may not be required for some tasks. For example, serving staff members and bellpersons (porters) do not need to directly communicate with each other, so that they can be classified into different groups. In addition, communications may not be required from geographical viewpoint. For example, when a branch office A and a branch office B are remotely located and do not need to frequently communicate with each other, they can be classified into different groups.

These initial settings including the user registration can be performed, for example, by an operation manager connecting to the management apparatus 100 from a manager terminal, not shown, to use the registration and setting function provided by the management apparatus 100.

The communication control section 112 of the management apparatus 100 functions as control sections including a first control section and a second control section. The first control section controls broadcast of utterance voice data received from one user terminal 500 to the other user terminals 500. The second control section chronologically accumulates the result of utterance voice recognition from voice recognition processing on the received utterance voice data in the user-to-user communication history 123 and controls text delivery such that the communication history 123 is displayed in synchronization on all the user terminals 500 including the user terminal 500 of the user who performed the utterance.

The function provided by the first control section is broadcast of utterance voice data. The utterance voice data mainly includes voice data representing user’s utterance. When the voice synthesis function is included as described above, the synthesized voice data produced artificially from the text information input on the user terminal 500 is also broadcast by the first control section.

The function provided by the second control section is broadcast of the text representing the result of voice recognition of the user’s utterance. All the voices input to the user terminals 500 and reproduced on the user terminals 500 are converted into texts which in turn are accumulated chronologically in the communication history 123 and displayed on the user terminals 500 in synchronization. The voice recognition section 113 performs voice recognition processing with the voice recognition dictionary 124 to output text data as the result of utterance voice recognition. The voice recognition processing can be performed by using any of known technologies.

The communication history information 123 is log information including contents of utterance of the users, together with time information, accumulated chronologically on a text basis. Voice data corresponding to each of the texts can be stored as a voice file in a predetermined storage region, and the position of the stored voice file is recorded in the communication history 123. The communication history information 123 is created and accumulated for each communication group. The result of voice quality evaluation can be accumulated in the communication history information 123 or accumulated in an individual storage region in association with the utterance content.

FIG. 4 is a diagram showing an example of the communication history 123 displayed on the user terminals 500. Each of the user terminals 500 receives the communication history 123 from the management apparatus 100 in real time or at a predetermined time, and the display thereof is synchronized among users. The users can chronologically refer to the communication log.

As in the example of FIG. 4, each user terminal 500 chronologically displays the utterance content of the user of that terminal 500 and the utterance contents of the other users in a display field D to share the communication history 123 accumulated in the management apparatus 100 as log information. In the display field D, each text representing user’s own utterance may be accompanied by a microphone mark H, and the users other than the utterer may be shown by a speaker mark M instead of the microphone mark H in the display field D.

FIG. 5 is a diagram for explaining a notification setting function provided on the user terminal 500. The user can input a keyword and set notification means on a notification setting screen. The notification means associated with one or more keywords is stored as notification setting information in the storage section 560 of the user terminal 500. The notification setting function is controlled by the notification setting section 520A. The notification setting section 520A may be included in the communication application control section 520.

Examples of the keyword include the user’s name, the category name of a work which the user is in charge of or involved in, the name of a location which the user is in charge of or involved in, and a particular keyword such as “check” or “soon” appearing during communication. The notification means includes a vibration notification performed by the vibration apparatus 570 and a message notification. An example of the message notification is a function of displaying, on a pop-up screen different from the display field D shown in FIG. 4, the text representing the received utterance content or a different message indicating the reception of a message without displaying the utterance content. For example, the message displayed on the pop-up screen may include a keyword (such as emergency, soon, and check) used to determine the necessity of the notification.

The display control may be performed such that the pop-up screen is displayed at the forefront of the application screen including the display field D or the pop-up screen is displayed on a lock screen of the user terminal 500. Together with the display of the pop-up screen, an LED light provided for the user terminal 500 may be illuminated or blinked, for example.

In the display control of received text information, the user terminal 500 (communication application control section 520) determines whether or not the text information includes any keyword within the notification setting information, and in response to determining that any keyword is included, actuates the notification means associated with the keyword to notify the user. When the notification means is the vibration notification, the communication application control section 520 operates the vibration apparatus 570 in a predetermined vibration pattern to vibrate the user terminal 500. When the notification means is the message notification, the communication application control section 520 produces a pop-up screen including the received result of voice recognition (utterance content) and displays the produced pop-up screen on the user terminal 500, independently of the display control in the display field D.

The vibration function can include a plurality of vibration patterns such that a different one of the vibration patterns is used for each notification setting.

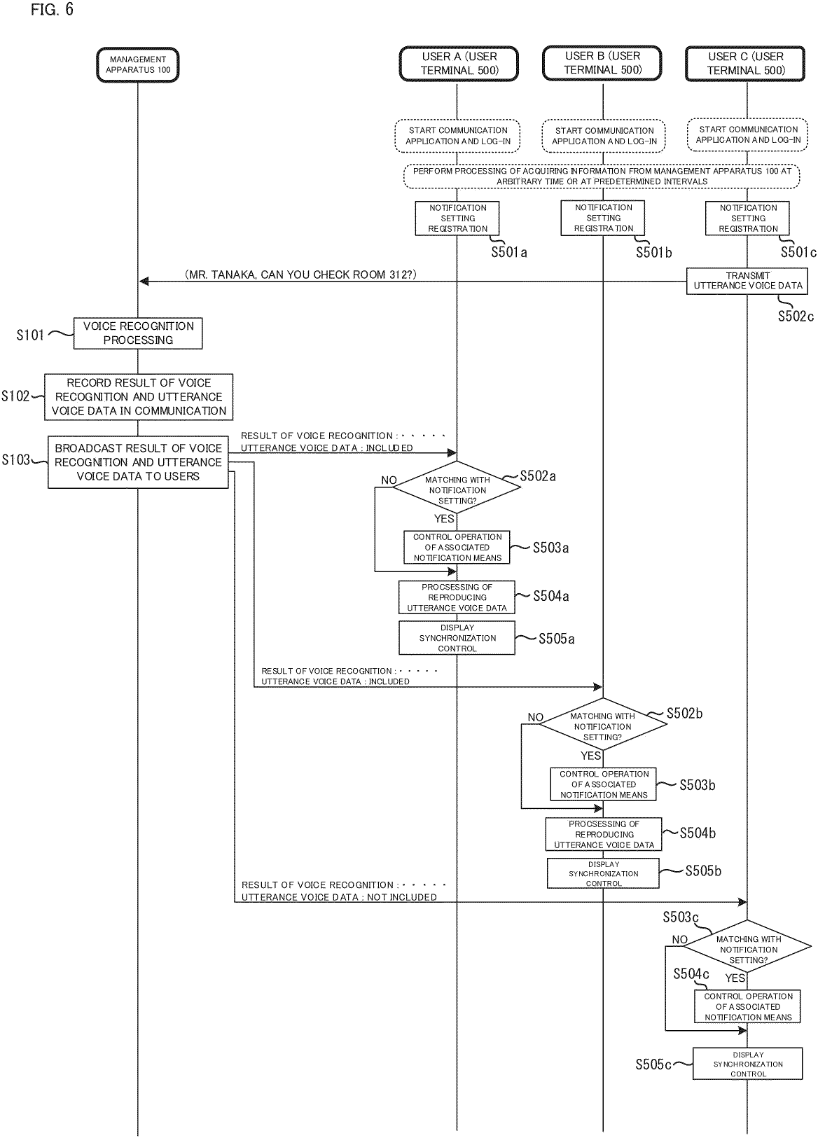

FIG. 6 is a diagram showing a flow of processing performed in the communication system according to Embodiment 1.

Each of the users starts the communication application control section 520 on his user terminal 500, and the communication application control section 520 performs processing for connection to the management apparatus 100. Each user enters his user ID and password on a predetermined log-in screen to log in to the management apparatus 100. The log-in authentication processing is performed by the user management section 111. After the log-in, each user terminal 500 performs processing of acquiring information from the management apparatus 100 at an arbitrary time or at predetermined time intervals.

Each user performs notification setting registration for registering notification setting information by inputting a keyword on the notification setting screen shown in FIG. 5 and selecting notification means associated with the input keyword (S501a, S501b, and S501c). The notification setting registration may be performed by the user at any time in connection with the management apparatus 100 or not in connection with the management apparatus 100.

When the user C performs utterance, the communication application control section 520 collects the voice of that utterance and transmits the utterance voice data to the management apparatus 100 (S502c). The voice recognition section 113 of the management apparatus 100 performs voice recognition processing on the received utterance voice data (S101) and outputs the result of voice recognition of the utterance content. The communication control section 112 stores the result of voice recognition in the communication history 123 and stores the utterance voice data in the storage apparatus 120 (S102). The utterance voice data and the corresponding result of voice recognition are stored in association.

The communication control section 112 transmits the result of voice recognition for display synchronization and the utterance voice data to the user terminal 500 of the user A (S103). The user terminal 500 of the user A performs local check processing based on the notification setting function (S502a). The local check processing is processing of matching the received result of voice recognition with the keywords within the registered notification setting information to determine whether or not the result of voice recognition includes any of the keywords. In response to determining that the result of voice recognition includes any of the keywords within the notification setting information (YES at S502a), the communication application control section 520 performs notification processing with the associated notification means (S503a). The communication application control section 520 performs automatic reproduction processing on the received utterance voice data to output the reproduced utterance voice (S504a), and displays the utterance content of text form corresponding to the output reproduced utterance voice in the display field D (S505a). The user terminal 500 of the user B performs similar operations (S502b to S505b) .

While the user terminal 500 of the user C corresponding to the utterer has the local check function (S503c), the user C is the utterer and thus the local check processing is omitted (alternatively, “NO” branch is selected at all times for the utterer after step S503c). Since the communication control section 112 does not transmit the utterance voice data to the user C who performs the utterance, the communication application control section 520 omits automatic reproduction processing on utterance voice data and displays the utterance content of text form corresponding to the utterance voice in the display field D (S505c).

Some utterance contents may cover two or more notification settings. For example, when the utterance content is “Clean the entrance soon,” it covers both a notification setting 1 and a notification setting 2 in the example of FIG. 5. When the notification setting 1 and the notification setting 2 include the same notification means, either one of the notification means may be controlled to operate. When the notification setting 1 and the notification setting 2 include different notification means, one of the notification means may be controlled to operate by previously assigning different degrees of priority to those notification settings. Alternatively, when the notification setting 1 and the notification setting 2 include different notification means, both the notification means may be controlled to operate.

### Embodiment 2

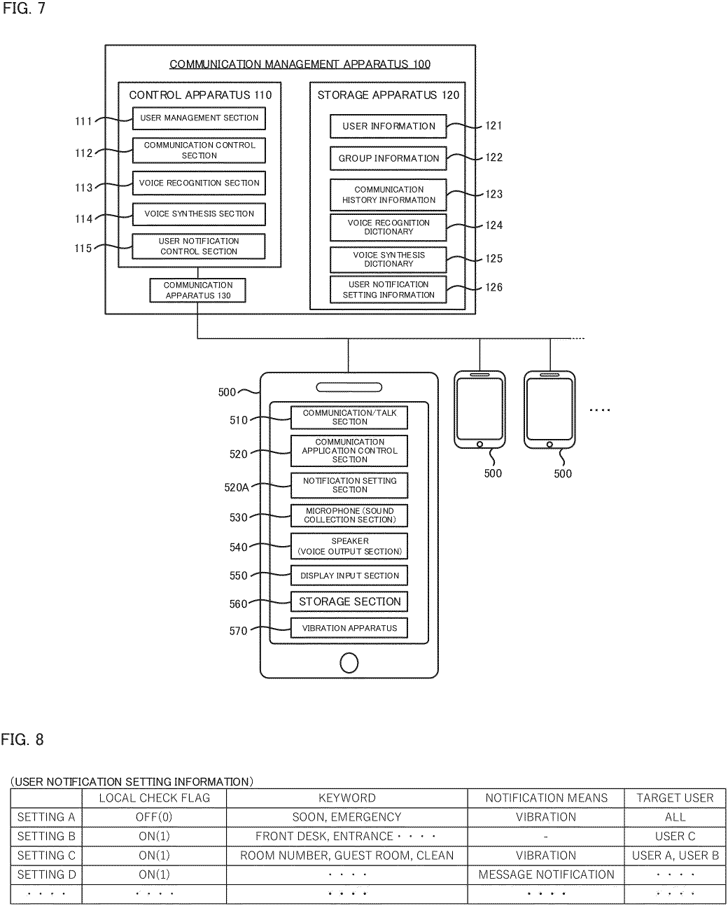

FIGS. 7 to 9 are diagrams showing the configuration of a network of a communication system according to Embodiment 2. The communication system according to Embodiment 2 differs from Embodiment 1 described above in that the management apparatus 100 has a notification setting function similar to that of the user terminal 500 and actively controls notification operation on the user terminal 500. It should be noted that the same components as those in Embodiment 1 are designated with the same reference numerals and their description is omitted.

FIG. 7 is a block diagram showing the configurations of the communication management apparatus 100 and the user terminal 500 according to Embodiment 2. As compared with FIG. 2 illustrating Embodiment 1, the management apparatus 100 includes a user notification control section 115 and user notification setting information 126.

As described above, the user notification setting in the management apparatus 100 can be performed by an operation manager connecting to the management apparatus 100 from a manager terminal, not shown, to use the registration and setting function provided by the management apparatus 100.

FIG. 8 is a diagram showing exemplary user notification setting information. The user notification setting information includes items of a local check flag (OFF(0) or ON(1)), keyword, notification means, and target user. The local check flag is information for controlling whether the notification function is valid (should be performed) or invalid (should be omitted) on the user terminal 500. The keyword and the notification means are similar to those for the notification setting on the user terminal 500. The target user is information for specifying one or more users subjected to notification control for each setting such that one or some of the users or all the users can be set as appropriate. As described above, depending on the work category or location, one or more of the users in the communication group can be in charge or involved. Thus, any of the users who should be or preferably is notified can be selected and registered previously for each keyword. In some cases, all the users should be or preferably are notified, for example when all the users should be contacted or an emergency response is needed. In this case, “all users” can be specified as the target user to allow the management apparatus 100 to cause each user terminal 500 to perform the notification operation set with the notification means regardless of the presence or absence of the notification setting on the user terminal 500 (presence or absence of keyword registration).

In Embodiment 1 described above, each user registers any keyword based on his individual judgement, and when an utterance content from one of the users matches any of the registered keywords, the associated user terminal 500 performs the predetermined notification operation. Since the users perform individual setting, the resulting notification settings may vary among the users. For example, even when an utterance content includes “soon” or “emergency,” the notification operation on the user terminal 500 is not performed if any keyword corresponding to those words is not registered.

Embodiment 2 provides the function of allowing each user to individually perform the notification setting and allows the management apparatus 100 to perform the notification setting for one or more users from a management standpoint, thereby achieving a configuration which ensures both the degree of freedom for each user and the enhanced management.

In addition, the local check flag can be set to perform both the notification operation controlled by the management apparatus 100 and the notification operation set by the user terminal 500, prioritize the notification operation set by the user terminal 500, or prioritize the notification operation on the management apparatus 100 without performing the notification operation set by the user terminal 500.

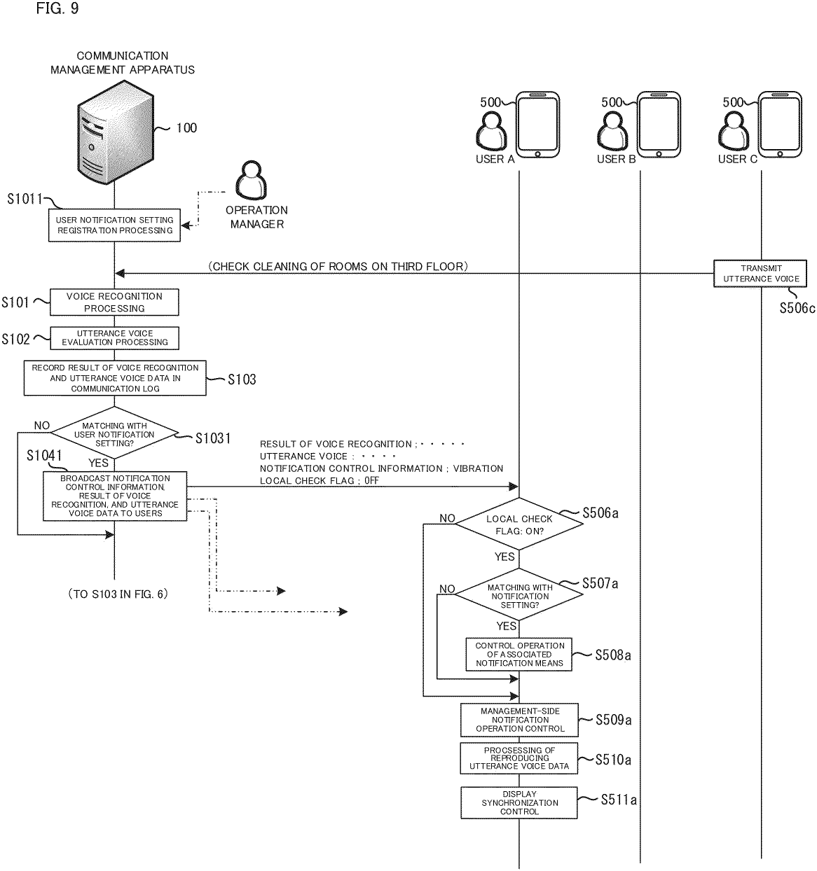

FIG. 9 is a diagram showing a flow of processing performed in the communication system according to Embodiment 2. It should be noted that the same processing operations as those in Embodiment 1 are designated with the same reference numerals and their description is omitted.

The operation manager registers user notification setting on the predetermined manager terminal. The registration processing of the user notification setting is performed by the user notification control section 115 (S1011).

When the user C performs utterance, the communication application control section 520 collects the voice of that utterance and transmits the utterance voice data to the management apparatus 100 (S506c). The voice recognition section 113 of the management apparatus 100 performs voice recognition processing on the received utterance voice data (S101) and outputs the result of voice recognition of the utterance content. The communication control section 112 stores the result of voice recognition in the communication history 123 and stores the utterance voice data in the storage apparatus 120 (S102). The utterance voice data and the corresponding result of voice recognition are stored in association.

The user notification control section 115 performs user notification processing (S1031). The user notification processing is management-side check processing in the management apparatus 100, and the details of the processing are identical to the local check processing performed on the user terminal 500. The user notification control section 115 performs the user notification processing of matching the result of voice recognition output from the voice recognition section 113 with the keywords within the registered user notification setting information to determine whether or not the result of voice recognition includes any of the keywords. In response to determining that the result of voice recognition includes any of the keywords within the user notification setting information (YES at S1031), the communication control section 112 extracts the associated local check flag, notification means, and target user specified in the notification setting including the keyword.

The communication control section 112 transmits the result of voice recognition for display synchronization, the utterance voice data, the notification control information including the notification means, and local check flag to the user terminal 500 of the target user specified in the user notification setting. In the example of FIG. 9, the result of voice recognition for display synchronization, the utterance voice data, notification control information (vibration), and local check flag (OFF) are transmitted to the user terminal 500 of the user A (S1041). The communication control section 112 transmits the result of voice recognition for display synchronization and the utterance voice data to the user not specified in the user notification setting except the utterer at step S1041. The communication control section 112 transmits only the result of voice recognition for display synchronization to the user C corresponding to the utterer at step S1041.

On the user terminal 500 of the user A, the communication application control section 520 refers to and sees the received local check flag (S506a). In the example of FIG. 9, the local check flag is OFF, so that the local check processing on the user terminal 500 is skipped and omitted, and the operation control is performed based on the notification control information received from the management apparatus 100 (S509a). The communication application control section 520 performs automatic reproduction processing on the received utterance voice data to output the reproduced utterance voice (S510a), and displays the utterance content of text form corresponding to the output reproduced utterance voice in the display field D (S511a).

In the example of FIG. 9, the local check flag is OFF as described above and the notification operation is made to be performed based on the setting on the management apparatus 100 regardless of the notification setting on the user terminal 500. Alternatively, when the local check flag is ON, the control proceeds to YES at step 506a to perform operation at step S507a as shown in FIG. 9. Step S507a is local check processing based on the notification setting function on the user terminal 500, including matching the received result of voice recognition with the keywords within the registered notification setting information on the user terminal 500 to determine whether or not the result of voice recognition includes any of the keywords. In response to determining that the result of voice recognition includes any of the keywords (YES at S507a), the communication application control section 520 performs notification processing with the associated notification means (S508a).

As described above, both the notification operation set on the management apparatus 100 and the notification operation set on the user terminal 500 can be provided, and in this case, one of them can be prioritized or both can be performed. At step S1031 in FIG. 6, when the management-side check processing determines that no match is found (NO at S1031), the control proceeds to step S103 in FIG. 6, and then the notification control can be performed by the local check processing on the user terminal 500.

As described above in Embodiment 1, a message may be displayed on a pop-up screen based on the notification setting in Embodiment 2 and include a keyword (such as emergency, soon, or check) used to determine the necessity of the notification. In addition, the notification setting information in Embodiment 2 is set on each of the management apparatus 100 and the user terminal 500, so that the pop-up screen may show the user which setting information is used to perform the notification.

### Embodiment 3

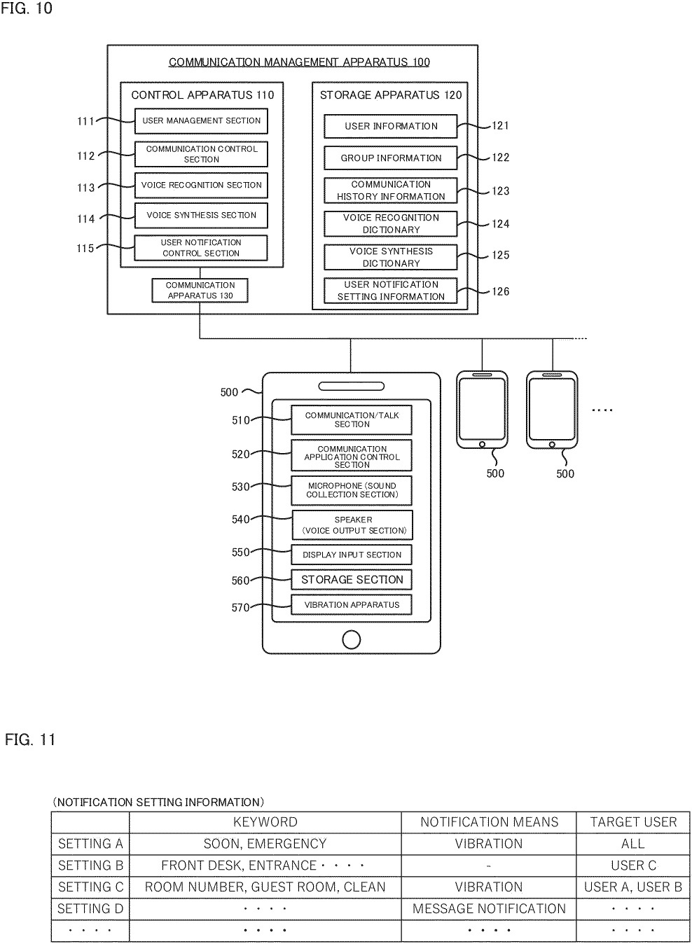

FIGS. 10 to 12 are diagrams showing network of a communication system according to Embodiment 2. The communication system according to Embodiment 3 differs from Embodiments 1 and 2 in that the entire notification setting function is provided by the management apparatus 100. Specifically, the management apparatus 100 manages both the user notification setting information set by the operation manager and/or the notification setting information set by the user terminal 500 to entirely manage the control of notification operation on the user terminal 500.

FIG. 10 is a block diagram showing the configurations of the communication management apparatus 100 and the user terminal 500 according to Embodiment 3. Similarly to Embodiment 2 described above, the management apparatus 100 includes the user notification control section 115 and the user notification setting information 126, while the user terminal 500 does not include the notification setting section 520A and does not have the notification setting information therein.

FIG. 11 is a diagram showing an example of notification setting information. The notification setting information according to Embodiment 3 includes information registered, for example, by an operation manager connecting to the management apparatus 100 from a manager terminal, not shown, to use the registration and setting function provided by the management apparatus 100, and information registered by the user terminal 500 connecting to the management apparatus 100 to use the registration and setting function provided by the management apparatus 100.

The latter notification setting information set individually by each user on the user terminal 500 is controlled to register himself as a target user. This configuration allows the collective management of the setting for the individual users and the setting on the management apparatus 100.

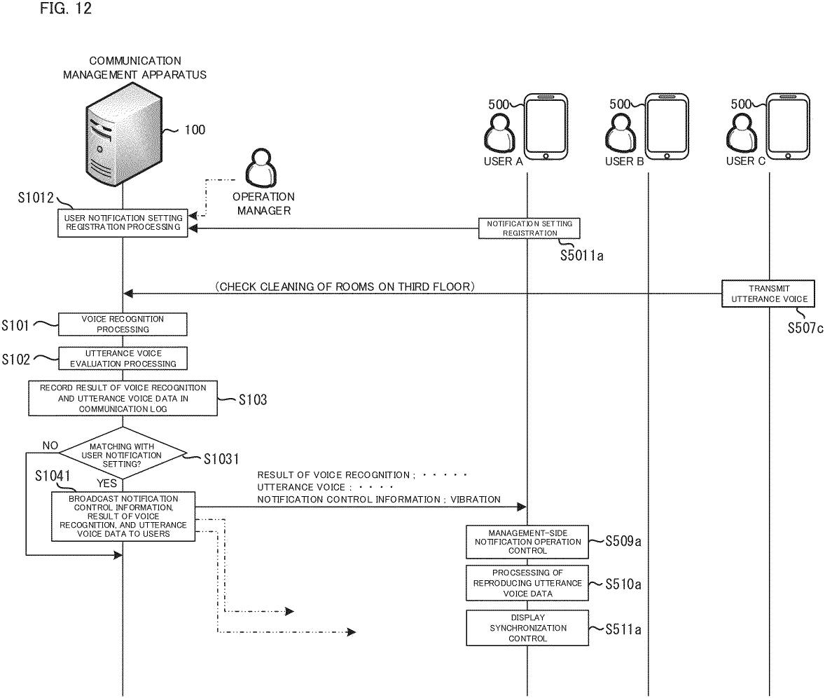

FIG. 12 is a diagram showing a flow of processing performed in the communication system according to Embodiment 3. It should be noted that the same processing operations as those in FIG. 6 or FIG. 9 are designated with the same reference numerals and their description is omitted.

The operation manager registers user notification setting on the predetermined manager terminal. The registration processing of the user notification setting is performed by the user notification control section 115 (S1011). In response to a request for registering the notification setting information from each user terminal 500, the user notification control section 115 can provide, for example, the notification setting screen shown in FIG. 5 to allow the user to set a keyword and associated notification means.

When the user C performs utterance, the communication application control section 520 collects the voice of that utterance and transmits the utterance voice data to the management apparatus 100 (S507c). The voice recognition section 113 of the management apparatus 100 performs voice recognition processing on the received utterance voice data (S101) and outputs the result of voice recognition of the utterance content. The communication control section 112 stores the result of voice recognition in the communication history 123 and stores the utterance voice data in the storage apparatus 120 (S102). The utterance voice data and the corresponding result of voice recognition are stored in association.

The user notification control section 115 performs user notification processing (S1031). In response to determining that the result of voice recognition includes any of the keywords within the user notification setting information (YES at S1031), the communication control section 121 extracts the associated notification means and target user specified in the notification setting including the keyword.

The communication control section 112 transmits the result of voice recognition for display synchronization, the utterance voice data, and the notification control information including the notification means to the user terminal 500 of the target user specified in the user notification setting. The communication control section 112 transmits the result of voice recognition for display synchronization and the utterance voice data to the user terminal 500 of the user not specified in the user notification setting at step S1041. The communication control section 112 transmits only the result of voice recognition for display synchronization to the user C corresponding to the utterer at step S1041.

On the user terminal 500 of the user A, the communication application control section 520 performs operation control based on the notification control information received from the management apparatus 100 (S509a). The communication application control section 520 performs automatic reproduction processing on the received utterance voice data to output the reproduced utterance voice (S510a), and displays the utterance content of text form corresponding to the output reproduced utterance voice in the display field D (S511a).

As described above, when the result of voice recognition covers two or more of the notification setting information pieces collectively managed on the management apparatus 100, those control information pieces may be transmitted to cause the user terminal 500 to perform the respective associated notification operations, or one of the notification setting information pieces may be selected and transmitted based on a predetermined degree of priority.

As described in Embodiments 1 and 2, a message may be displayed on a pop-up screen based on the notification setting in Embodiment 3 and include, for example, a keyword (such as emergency, soon, or check) used to determine the necessity of the notification. In Embodiment 3, the notification setting information is managed entirely on the management apparatus 100, but the registration of the notification setting information can be performed on both the management apparatus 100 and the user terminal 500, and the managed information indicates one of the management apparatus 100 and the user terminal 500 on which the information has been set or registered. Thus, similarly to Embodiment 2, the pop-up screen may show the user which setting information is used to perform the notification.

Various embodiments of the present invention have been described. The functions of the communication management apparatus 100 and the use terminal 500 can be implemented by a program. A computer program previously provided for implementing the functions can be stored on an auxiliary storage apparatus, the program stored on the auxiliary storage apparatus can be read by a control section such as a CPU to a main storage apparatus, and the program read to the main storage apparatus can be executed by the control section to perform the functions of the components.

The program may be recorded on a computer readable recording medium and provided for the computer. Examples of the computer readable recording medium include optical disks such as a CD-ROM, phase-change optical disks such as a DVD-ROM, magneto-optical disks such as a Magnet-Optical (MO) disk and Mini Disk (MD) , magnetic disks such as a floppy disk® and removable hard disk, and memory cards such as a compact flash®, smart media, SD memory card, and memory stick. Hardware apparatuses such as an integrated circuit (such as an IC chip) designed and configured specifically for the purpose of the present invention are included in the recording medium.

While various embodiments of the present invention have been described above, these embodiments are only illustrative and are not intended to limit the scope of the present invention. These novel embodiments can be implemented in other different forms, and various omissions, substitutions, and modifications can be made thereto without departing from the spirit or scope of the present invention. These embodiment and their variations are encompassed within the spirit or scope of the present invention and within the invention set forth in the claims and the equivalents thereof.

### Description of the Reference Numerals

100 COMMUNICATION MANAGEMENT APPARATUS
110 CONTROL APPARATUS
111 USER MANAGEMENT SECTION
112 COMMUNICATION CONTROL SECTION (FIRST CONTROL SECTION, SECOND CONTROL SECTION)
113 VOICE RECOGNITION SECTION
114 VOICE SYNTHESIS SECTION
115 USER NOTIFICATION CONTROL SECTION
120 STORAGE APPARATUS
121 USER INFORMATION
122 GROUP INFORMATION
123 COMMUNICATION HISTORY INFORMATION
124 VOICE RECOGNITION DICTIONARY
125 VOICE SYNTHESIS DICTIONARY
126 USER NOTIFICATION SETTING INFORMATION
130 COMMUNICATION APPARATUS
500 USER TERMINAL (MOBILE COMMUNICATION TERMINAL)
510 COMMUNICATION/TALK SECTION
520 COMMUNICATION APPLICATION CONTROL SECTION (USER APPLICACTION CONTROL SECTION)
520A NOTIFICATION SETTING SECTION
530 MICROPHONE (SOUND COLLECTION SECTION)
540 SPEAKER (VOICE OUTPUT SECTION)
550 DISPLAY INPUT SECTION
560 STORAGE SECTION
570 VIBRATION APPARATUS
D DISPLAY FIELD

1. A communication system in which a plurality of users carry their respective mobile communication terminals and a voice of utterance of one of the users input to his mobile communication terminal is broadcast to the mobile communication terminals of the other users, comprising:
a communication management apparatus connected to each of the mobile communication terminals through wireless communication,
wherein the communication management apparatus includes:
a communication control section having a first control section configured to broadcast utterance voice data received from one of the mobile communication terminals to the other mobile communication terminals and a second control section configured to chronologically accumulate a result of utterance voice recognition from voice recognition processing on the received utterance voice data as a user-to-user communication history and to control text delivery such that the communication history is displayed on the mobile communication terminals in synchronization, and
each of the mobile communication terminals includes:
a notification setting section configured to control registration of notification setting information including a keyword and a predetermined notification function associated with the keyword, the predetermined notification function being provided for the mobile communication terminal; and
a user application control section configured to perform processing of reproducing the utterance voice data received from the communication management apparatus, processing of displaying the result of utterance voice recognition, local check processing of matching the result of utterance voice recognition with the keyword included in the notification setting information, and operation control for the notification function associated with keyword included in the result of utterance voice recognition.

2. The communication system according to claim 1, wherein the notification function is a vibration notification function configured to be performed by a vibration apparatus included in the mobile communication terminal and/or a message notification function configured to be performed by display of a pop-up screen on the mobile communication terminal.

3. The communication system according to claim 2, wherein the message notification function includes displaying, on the pop-up screen, the keyword matched in the local check processing.

4. The communication system according to claim 1 , wherein the communication management apparatus further includes a user notification control section configured to control registration of user notification setting information including a keyword and a predetermined notification function associated with the keyword on a manager terminal operable by an operation manager, the predetermined notification function being provided for the mobile communication terminal, and
the communication control section is configured to perform management-side check processing of matching the result of utterance voice recognition to be transmitted to the mobile communication terminal with the keyword included in the user notification setting information, extract operation control information for the user notification function associated with the keyword included in the result of utterance voice recognition, and transmit the extracted operation control information to the mobile communication terminal.

5. The communication system according to claim 4, wherein the user notification setting information includes flag information indicating whether the local check processing on the mobile communication terminal should be performed or not,
the communication control section is configured to transmit the extracted operation control information and the flag information to the mobile communication terminal, and
the user application control section is configured to determine whether the local check processing should be performed or not based on the received flag information, and in response to determining that the local check processing should not be performed, perform only operation control for the notification function using the operation control information based on the received user notification setting information.

6. The communication system according to claim 5, wherein the user application control section is configured to determine whether the local check processing should be performed or not based on the received flag information, and in response to determining that the local check processing should be performed, perform the local check processing to perform operation control for the notification function associated with the keyword included in the result of utterance voice recognition and set on the mobile communication terminal, and perform operation control for the notification function using the operation control information based on the received user notification setting information.

7. The communication system according to claim 5, wherein the user application control section is configured to display, on the pop-up screen, the keyword matched in the management-side check processing or the local check processing, and one of the management-side check processing and the local check processing that has determined the matching of the keyword.

8. A communication system in which a plurality of users carry their respective mobile communication terminals and a voice of utterance of one of the users input to his mobile communication terminal is broadcast to the mobile communication terminals of the other users, comprising:
a communication control section having a first control section configured to broadcast utterance voice data received from one of the mobile communication terminals to the other mobile communication terminals and a second control section configured to chronologically accumulate a result of utterance voice recognition from voice recognition processing on the received utterance voice data as a user-to-user communication history and to control text delivery such that the communication history is displayed on the mobile communication terminals in synchronization; and
a user notification control section configured to control registration of notification setting information including a keyword and a predetermined notification function associated with the keyword, the predetermined notification function being provided for the mobile communication terminal,
wherein the communication control section is configured to match the result of utterance voice recognition with the keyword included in the notification setting information, extract operation control information for the notification function associated with the keyword included in the result of utterance voice recognition, and transmit the extracted operation control information to the mobile communication terminal.

9. The communication system according to claim 2, wherein the communication management apparatus further includes a user notification control section configured to control registration of user notification setting information including a keyword and a predetermined notification function associated with the keyword on a manager terminal operable by an operation manager, the predetermined notification function being provided for the mobile communication terminal, and
the communication control section is configured to perform management-side check processing of matching the result of utterance voice recognition to be transmitted to the mobile communication terminal with the keyword included in the user notification setting information, extract operation control information for the user notification function associated with the keyword included in the result of utterance voice recognition, and transmit the extracted operation control information to the mobile communication terminal.

10. The communication system according to claim 9, wherein the user notification setting information includes flag information indicating whether the local check processing on the mobile communication terminal should be performed or not,
the communication control section is configured to transmit the extracted operation control information and the flag information to the mobile communication terminal, and
the user application control section is configured to determine whether the local check processing should be performed or not based on the received flag information, and in response to determining that the local check processing should not be performed, perform only operation control for the notification function using the operation control information based on the received user notification setting information.

11. The communication system according to claim 10, wherein the user application control section is configured to determine whether the local check processing should be performed or not based on the received flag information, and in response to determining that the local check processing should be performed, perform the local check processing to perform operation control for the notification function associated with the keyword included in the result of utterance voice recognition and set on the mobile communication terminal, and perform operation control for the notification function using the operation control information based on the received user notification setting information.

12. The communication system according to claim 11, wherein the user application control section is configured to display, on the pop-up screen, the keyword matched in the management-side check processing or the local check processing, and one of the management-side check processing and the local check processing that has determined the matching of the keyword.
